(19) United States
(12) Patent Application Publication
(10) Pub. No.: US 2017/0056941 A1
(43) Pub. Date: Mar. 2, 2017

(54) COMPOSITION AND METHOD FOR TREATING AN HERBICIDE

(71) Applicant: Young Living Essential Oils, LC, Lehi, UT (US)

(72) Inventor: D. Gary Young, Alpine, UT (US)

(21) Appl. No.: 15/250,074

(22) Filed: Aug. 29, 2016

Related U.S. Application Data
(60) Provisional application No. 62/210,792, filed on Aug. 27, 2015.

(51) Int. Cl. B09C 1/02; A23L 19/00; B09C 1/08; A23L 5/20

(52) U.S. Cl. CPC B09C 1/025; A23L 5/27; A23L 19/00; B09C 1/08; A23V 2002/00

(57) ABSTRACT

A composition and method for decomposing and/or inhibiting the function of an herbicide, such as an herbicide in the soil or on a food product (e.g., fruits and vegetables). The composition contains one or more essential oils or plant extracts. A method of using the composition to decompose or inhibit glyphosate and other herbicides. The composition can include one or more essential oils or plant extracts from the following plants tarragon, ginger, peppermint, juniper, fennel, lemongrass, anise, and patchouli essential oils.

### BACKGROUND

Herbicides are commonly used to kill weeds and other plants. Herbicides are believed to cause many soils to become infertile for agriculture, causing desertification and low crop production. One common herbicide is glyphosate, which commonly used to kill weeds in commercial crops. When sprayed, portions of this herbicide falls onto the soil and rapidly bind itself to soil particles, where it can remain inactivated for months. This herbicide may also remain on fruit and vegetables and later consumed, which may harm the consumer.

### SUMMARY

The present invention provides a composition and method to decompose and/or inhibit the function of an herbicide, such as an herbicide in the soil or on a food product (e.g., fruits and/or vegetables). The composition can contain one or more essential oils and a method of using this composition to decompose or inhibit glyphosate and other herbicides. Some aspects of the invention include a composition that includes one or more essential oils or plant extracts from the following plants tarragon, ginger, peppermint, juniper, fennel, lemongrass, anise, and patchouli essential oils. Other aspects include a method of applying the composition to decompose and/or inhibit the function of an herbicide in the soil.

### DETAILED DESCRIPTION

This specification describes exemplary embodiments and applications of the invention. The invention, however, is not limited to these exemplary embodiments and applications or to the manner in which the exemplary embodiments and applications operate or are described herein. Where reference is made to a list of elements (e.g., elements a, b, c), such reference is intended to include any one of the listed elements by itself, any combination of less than all of the listed elements, and/or a combination of all of the listed elements.

Numerical data may be expressed or presented herein in a range format. It is to be understood that such a range format is used merely for convenience and brevity and thus should be interpreted flexibly to include not only the numerical values explicitly recited as the limits of the range, but also as including all the individual numerical values or sub-ranges encompassed within that range as if each numerical value and sub-range is explicitly recited. As an illustration, a numerical range of “about 1 to 5” should be interpreted to include not only the explicitly recited values of about 1 to 5, but also include individual values and sub-ranges within the indicated range. Thus, included in this numerical range are individual values such as 2, 3, and 4 and sub-ranges such as 1-3, 2-4, and 3-5, etc. This same principle applies to ranges reciting only one numerical value and should apply regardless of the breadth of the range or the characteristics being described.

The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present invention relates generally to a composition containing one or more essential oils or plant extracts and a method of using the composition to chemically alter an herbicide, dissolve the herbicide, render the herbicide non-toxic, and/or inhibit the function of the herbicide. Essential oils are naturally occurring aromatic liquids found in the roots, stems, bark, seeds, resin, flowers, and other parts of plants. These oils are fat soluble, non-water-based phytochemicals that include volatile organic compounds. The chemistry of any particular essential oil can be very complex and may consist of hundreds of different and unique chemical compounds. In nature, these oils give plants their distinctive smells, provide protection against disease, and assist in pollination. When separated from their parent plant, essential oils in their pure form are translucent with colors ranging from clear to pink or blue.

As mentioned, the composition includes one or more essential oils. Non-limiting examples of essential oils that may be included in the composition include essential oils from one or more of the following plants and their related plant species: ajowan, almond, allspice, aloe, ammi visnaga (khella), amyris, angelica, anise, apricot, arnica, avocado, copaiba, balsam, basil, bay laurel, benzoin, bergamot, bergaptene, birch, borage, boronia, buchu, cajeput, calalmus, calendula, camellia, cannabis, caraway, cardamom, carnation, carrot, cassia, castor, catnip, cedar, cedarwood, celery, chamomile (including blue chamomile, German chamomile, Moroccan chamomile, Moroccan wild chamomile, and Roman chamomile), champaca, cilantro, cinnamon, cistus, citronella, ciste, clary sage, clementine, clove, cocoa, coconut, combava petitgrain, coriander, cornmint, costus, cumin, cypress, davana, dill, dill weed, elemi, erideron (fleabane), eucalyptus, fennel, sweet fennel, fenugreek, fir, frankincense, galbanum, garlic, genet, geranium, ginger, ginsing, grapefruit, pink grapefruit, white grapefruit, grapeseed, hazelnut, helichrysum, hemp, honeysuckle, hyssop, immortelle, fragrant aster inula, Jamaican gold, jasmine, grandiflorum jasmine, jojoba, jobquille, juniper, lanolin, lantana camara, laurel nobilis, lavender, lemon, lemongrass, lime, litsea, litsea cubeba, lotus, macadamia, mace, mandarin, manuka, marigold, marjarom, massoia, melissa, mimosa, monarda, mugwort, musk, myrrh, myrtle, narcissus, neroli, niaouli, nutmeg, oakmoss, ocoteao, olibanum, opopanax, orange, blood orange, sweet orange, oregano, orris, osmanthus, palm, palmarosa, paprika, parsley, patchouli, peanut, pecan, pennyroyal, pepper, black pepper, peppermint, petitgrain, white pine, pine, primrose, ravensara anisata, redberry, rose, rosehip, rosemary, rosewood, rue, sage, sandalwood, seabuckthorn, sesame, shea, spikenard, spruce, blue spruce, St. John's wort, styrax, tagetes, tangerine, tea tree, thuja, thyme, tuberose, valerian, vanilla, verbena, vetiver, violete, vitex, walnut, wintergreen, wormwood, yarrow, and ylang ylang.

In some embodiments, as an alternative or addition to essential oils, the composition includes one or more plant extracts. Plant extracts are extracted from plant material using a solvent such as ethanol or water. Extracts may take the form of a tincture or powder form. Non-limiting examples of suitable plant extracts includes extracts from peppermint, almond, cinnamon, cloves, ginger, lemon, nutmeg, orange, pistachio, rose, spearmint, vanilla, violet, and wintergreen.

In some embodiments, the composition may include one or more essential oils or plant extracts in amounts from between at least about 1%, 5%, 10%, 15%, 20%, 25%, 30%, 50%, 75%, 90%, 95%, 99% or 100% by weight based on the total weight of the composition. Embodiments of the composition may also include less than about 1%, 5%, 10%, 15%, 20%, 25%, 30%, 50%, 75% 90%, 95%, 99% or 100%.

In some embodiments, the composition may include a blend of essential oils. Embodiments of the blend may include tarragon essential oil in amounts between about 0.1 to 80%, 1% to 60%, 10% to 50%, or 15% to 40% by weight based on the total weight of the blend. Embodiments of the blend may include ginger essential oil in amounts between about 0.1 to 80%, 1% to 60%, 10% to 50%, or 15% to 40% by weight based on the total weight of the blend. Embodiments of the blend may include peppermint essential oil in amounts between about 0.1 to 80%, 1% to 60%, 5% to 50%, or 10% to 40% by weight based on the total weight of the blend. Embodiments of the blend may include juniper essential oil in amounts between about 0.1 to 80%, 1% to 60%, 5% to 50%, or 5% to 30% by weight based on the total weight of the blend. Embodiments of the blend may include fennel essential oil in amounts between about 0.1 to 80%, 1% to 60%, 5% to 50%, or 5% to 30% by weight based on the total weight of the blend. Embodiments of the blend may include anise essential oil in amounts between about 0.1 to 80%, 1% to 60%, 3% to 50%, or 3% to 30% by weight based on the total weight of the blend. Embodiments of the blend may include patchouli essential oil in amounts between about 0.1 to 80%, 1% to 60%, 3% to 50%, or 3% to 30% by weight based on the total weight of the blend. Embodiments of the blend may include lemongrass essential oil in amounts between about 0.1 to 80%, 1% to 60%, 3% to 50%, or 3% to 30% by weight based on the total weight of the blend.

In some embodiments, the composition includes one or more surfactants, which may enable the composition to cling to plants and decompose herbicides on the plants. Surfactants are compounds that lower the surface tension between two liquids or between a liquid and a solid. Various types of surfactants may be used with the composition. In some instances, the surfactant is naturally-derived and non-toxic. Non-limiting examples include castile soap, yucca extract, soapwort, and quillaja bark extract.

In some embodiments, it is contemplated that the composition will be diluted in water, another solution, a carrier oil, and/or another diluting agent before it is applied to an herbicide or item containing an herbicide. For example, the composition may be diluted at a ratio of 1:1, 1:2, 1:3, 1:5, 1:10, 1:20, 1:100, 1:1000, 1:10,000, 1:100,000, 1:250,000, 1:500,000, 1:750,000, 1:1,000,000, or fewer parts of composition to diluting agent. Non-limiting examples of carrier oils include vegetable oils such as coconut oil, olive oil, grapeseed oil, sesame seed oil, sweet almond oil, wheat germ oil, sunflower seed oil, avocado oil, and canola oil.

In certain embodiments, where a diluting agent comprises water, the composition may include one or more emulsifiers to suspend the one or more essential oils in the water. An emulsifier may stabilize a suspension of one or more essential oils in water, which may otherwise be immiscible. Non-limiting examples of emulsifiers include lecithin (e.g., soy lecithin); proteins; gums; esters of fatty acids and poly hydroxyl substrates such as lactic acid, sucrose, and polysorbates; mono- and di-glycerides; stearoyl lactylates (e.g., sodium stearoyl lactylate); a surfactant as described above; sodium phosphates; detergents; emulsifying wax; and cetearyl alcohol.

The following compositions represent several exemplary compositions contemplated by the present invention.

Composition One

| Ingredients | Percent by Weight |
|---|---|
| Tarragon essential oil | 1-90% |
| Ginger essential oil | 1-50% |
| Peppermint essential oil | 0-50% |
| Juniper essential oil | 0-30% |
| Fennel essential oil | 0-30% |
| Anise essential oil | 0-30% |
| Patchouli essential oil | 0-30% |
| Lemongrass essential oil | 0-30% |

Composition Two

| Ingredients | Percent by Weight |
|---|---|
| Tarragon essential oil | 1-60% |
| Ginger essential oil | 1-60% |
| Peppermint essential oil | 1-50% |
| Juniper essential oil | 1-30% |
| Fennel essential oil | 1-20% |
| Anise essential oil | 0.5-20% |
| Patchouli essential oil | 0.5-20% |
| Lemongrass essential oil | 0.5-20% |

Through detailed laboratory testing, it has been found that a composition containing one or more essential oils and/or plant extracts appears to be capable of decomposing an herbicide, speeding the decomposition of an herbicide, and/or rendering an herbicide ineffective. In particular, the composition may have this effect on an herbicide containing glyphosate.

Accordingly, some aspects of the invention include a method of applying a composition of one or more essential oils and/or plant extracts, such as any of those previously described, to an herbicide or item containing an herbicide to chemically alter an herbicide, dissolve the herbicide, render the herbicide non-toxic, and/or inhibit the function of the herbicide. The method can include applying the composition in an undiluted form or a diluted form to an isolated herbicide, a fruit, a vegetable, another food product, a plant, or soil containing an herbicide. Accordingly, in some instances, the composition can be used in fields to improve the soil. In other instances, the composition can also be used as a fruit and vegetable wash. For example, the undiluted composition can include one or more essential oils and vinegar, which can be used in a method of soaking and cleaning fruits, vegetables, and other contaminated foods.

### EXAMPLES

A test was conducted, which comprised applying an herbicide to the soil. The herbicide was Roundup° weed killer from Monsanto Company, which contains glyphosate. The herbicide particularly included water-dispersible granules containing 747 grams of monoammonium salt of N-phosphonomethyl glycine per kilogram of product. The herbicide was applied to three outdoor soil samples: Samples B, C, and D. The herbicide was mixed with water from a farm water reservoir at a dosage of 1% p/p. The PH of the herbicide mixture was 4.3 and at a temperature of 59 degrees Fahrenheit. The herbicide was sprayed on Samples B, C, and D at doses of 1 liter per hectare, which is approximately the same way it is conventionally used in some agricultural practices. The temperature at the time of application of the herbicide was 68 degrees Fahrenheit.

A fourth soil sample, Sample A, located in approximately the same outdoor location was not exposed to the herbicide was used as a control sample.

Twenty-four hours after applying the herbicide, a liquid composition containing essential oils was applied to Samples C and D, each of which had been sprayed with the herbicide. Sample B was left unsprayed as a control sample. The composition consisted of a blend of essential oils called DiGize®, which is sold by Young Living Essential Oils, LC, and which is a blend of tarragon, ginger, peppermint, juniper, fennel, lemongrass, anise, and patchouli essential oils. The composition was diluted in water to a dosage of 0.001% composition to water. The PH of the composition was 4.5 and at a temperature of 60 degrees Fahrenheit. The composition was sprayed onto Samples C and D.

The soil samples were not irrigated during the testing period (approximately twenty days). Ten days after Sample C was sprayed with the diluted composition a sample of Sample C was taken from the sample area with sterile gloves. The sample was placed in a sterile bag. The bag was sent to a lab for analysis. Twenty days after Sample D was sprayed with the essential oils-water composition a sample of Sample D was taken and with sterile gloves was placed in a sterile bag. This bag was also sent to a lab for analysis. A sample of the soil from Samples A and B were also taken and sent to the same lab for analysis. The lab analyzed the levels of aminomethylphosphonic acid (AMPA) and glyphosate each sample. AMPA is one of the primary degradation products of glyphosate. The results of these tests are shown in Table 1, below.

TABLE 1

| | | AMPA | Glyphosate |
|---|---|---|---|
| Sample | Sample Description | (mg/kg) | (mg/kg) |
| A | Soil without Glyphosate | 0.00 | 0.00 |
| B | Soil with Glyphosate | 0.46 | 5.40 |
| C | Soil with Glyphosate taken 10 days | 0.26 | 0.53 |
| | after application of the essential | | |
| | oil composition | | |
| D | Soil with Glyphosate taken 20 days | 0.28 | 1.20 |
| | after application of the essential | | |
| | oil composition | | |

These test results show that the levels of glyphosate within the soil were lower in samples C and D, which had been applied with the essential oil composition, than in the controlled sample, which received no essential oil application. Accordingly, this test suggests the composition of essential oils may reduce the levels of glyphosate in soil by degrading or decomposing the glyphos ate.

Although specific embodiments and applications of the invention have been described in this specification, these embodiments and applications are exemplary only, and many variations are possible.

We claim:

1. A method for treating soil containing herbicide, the method comprising applying a composition containing one or more essential oils to the soil.

2. The method of claim 1, further comprising leaving the composition on the soil for one or more days.

3. The method of claim 1, wherein the composition includes one or more of tarragon, ginger, peppermint, juniper, fennel, lemongrass, anise, and patchouli essential oils.

4. The method of claim 1, wherein the composition includes two or more of tarragon, ginger, peppermint, juniper, fennel, lemongrass, anise, and patchouli essential oils.

5. The method of claim 1, wherein the composition includes three or more of tarragon, ginger, peppermint, juniper, fennel, lemongrass, anise, and patchouli essential oils.

6. The method of claim 1, wherein the composition includes four or more of tarragon, ginger, peppermint, juniper, fennel, lemongrass, anise, and patchouli essential oils.

7. The method of claim 1, wherein the composition contains one or more diluting agents diluting the one or more essential oils.

8. The method of claim 7, wherein the diluting agent comprises a vegetable oil carrier.

9. The method of claim 7, wherein the diluting agent comprises water.

10. The method of claim 9, wherein the composition contains one or more emulsifiers suspending the one or more essential oils in the water.

11. A method for cleaning herbicides from fruit or vegetables, the method comprising applying a composition containing one or more essential oils to the fruit or vegetables.

12. The method of claim 11, further comprising leaving the composition on the fruit or vegetables for one or more days.

13. The method of claim 11, wherein the composition includes one or more of tarragon, ginger, peppermint, juniper, fennel, lemongrass, anise, and patchouli essential oils.

14. The method of claim 11, wherein the composition includes two or more of tarragon, ginger, peppermint, juniper, fennel, lemongrass, anise, and patchouli essential oils.

15. The method of claim 11, wherein the composition includes three or more of tarragon, ginger, peppermint, juniper, fennel, lemongrass, anise, and patchouli essential oils.

16. The method of claim 11, wherein the composition includes four or more of tarragon, ginger, peppermint, juniper, fennel, lemongrass, anise, and patchouli essential oils.

17. The method of claim 11, wherein the composition includes one or more surfactants lowering a surface tension of the composition and enabling the composition to cling to a surface of the fruit or vegetables.

18. A method for treating a surface previously treated with herbicide, the method comprising applying a composition containing one or more essential oils to the surface, wherein the composition includes three or more of tarragon, ginger, peppermint, juniper, fennel, lemongrass, anise, and patchouli essential oils.

19. The method of claim 18, further comprising leaving the composition on the surface for one or more days.

20. The method of claim 18, wherein the surface comprises one or more of soil, a fruit, and a vegetable.
